(19) United States
(12) Patent Application Publication
(10) Pub. No.: US 2017/0280413 A1
(43) Pub. Date: Sep. 28, 2017

(54) BASE STATION LOCATION DETERMINATION

(71) Applicant: QUALCOMM Incorporated, San Diego, CA (US)

(72) Inventors: Gengsheng ZHANG, Cupertino, CA (US); Weihua GAO, San Jose, CA (US); Dominic Gerard FARMER, Los Gatos, CA (US)

(21) Appl. No.: 15/080,058

(22) Filed: Mar. 24, 2016

(51) Int. Cl. H04W 64/00; G01S 5/02; H04W 4/02

(52) U.S. Cl. CPC H04W 64/003; H04W 4/02; H04W 4/023; G01S 5/0236

(57) ABSTRACT

A method of determining a location of a base station includes: receiving, at a mobile device from a location server, a base station identifier (BSID) of the base station and two or more candidate locations of the base station; receiving a signal, at the mobile device from the base station identified by the BSID; and selecting, at the mobile device, a particular candidate location from the two or more candidate locations based on a characteristic determined from the signal. A method of identifying an actual location of a base station includes: transmitting, from a location server to a disambiguating mobile device, a base station identifier (BSID) of the base station and two or more candidate locations of the base station; and receiving, at the location server from the disambiguating mobile device, an indication of the actual location of the base station from among the two or more candidate locations.

### BACKGROUND

It is often desirable to know the location of a mobile device such as a cellular phone. For example, a location services (LCS) client may desire to know the location of a mobile device in the case of an emergency services call or to provide some service to the user of the mobile device such as navigation assistance or direction finding. The terms “location” and “position” are synonymous and are used interchangeably herein. One method of determining the location of a mobile device is based on measurements of the times of signal arrival from multiple antennas. For example, a mobile device may determine a range to a base station by measuring a difference between a time a signal was transmitted from a base station and a time the signal was received by the mobile device. This range can be calculated for multiple base station antennas. When the positions of the base station antennas are known, the observed ranges may be used to calculate the location of the mobile device.

A mobile device may make use of assistance data sent from a base station, such as a Base Station Almanac (BSA) that contains location information and time bias information for one or more base stations, to perform location calculations and/or may send measurement information to a location server for position calculation. Examples of terrestrial positioning of a mobile device include Advanced Forward Link Trilateration (AFLT) in Code Division Multiple Access (CDMA) systems, and Observed Time Difference of Arrival (OTDOA) in the context of Wideband CDMA (WCDMA) and Long Term Evolution (LTE) systems. The accuracy of the mobile device location determined by terrestrial positioning is dependent on the base station locations and time biases stored in the BSA being accurate.

### SUMMARY

An example method of determining a location of a base station includes: receiving, at a mobile device from a location server, a base station identifier (BSID) of the base station and two or more candidate locations of the base station; receiving a signal, at the mobile device from the base station identified by the BSID; and selecting, at the mobile device, a particular candidate location from the two or more candidate locations based on a characteristic determined from the signal.

Implementations of such a method may include one or more of the following features. Selecting the particular candidate location from the two or more candidate locations includes selecting a candidate location of the two or more candidate locations that has a greatest correlation between the characteristic determined from the signal and a predicted signal characteristic associated with the particular candidate location. The method further includes determining a location of the mobile device, where: the predicted signal characteristic is a predicted distance between the mobile device and the particular candidate location based on the location of the mobile device and the particular candidate location; and the characteristic determined from the signal is a distance based on a time difference of arrival between the signal and at least one other signal from at least one other base station.

Also or alternatively, implementations of such a method may include one or more of the following features. The method further includes sending an indication of the particular candidate location to the location server. The method further includes determining a location of the mobile device, and wherein the indication of the particular candidate location includes an indication of the characteristic determined from the signal and the location of the mobile device. The indication of the particular candidate location comprises a likelihood value for each of the two or more candidate locations. The indication of the particular candidate location comprises a ranking of the two or more candidate locations.

Also or alternatively, implementations of such a method may include one or more of the following features. The method further includes receiving, at the mobile device from the location server, a time bias associated with the BSID. Receiving the BSID of the base station and the two or more candidate locations of the base station comprises receiving a base station almanac.

An example mobile device includes: a memory; a transceiver configured to receive signals from a base station and to send signals to the base station; and a processor operably coupled to the memory and the transceiver, wherein the processor is configured to: receive, from a location server, a base station identifier (BSID) of the base station and two or more candidate locations of the base station; receive a signal, from the base station identified by the BSID; determine a characteristic from the signal; and select a particular candidate location from the two or more candidate locations based on the characteristic determined from the signal.

Implementations of such a mobile device may include one or more of the following features. The processor is configured to select, as the particular candidate location, a candidate location from the two or more candidate locations with that has a greatest correlation between the characteristic determined from the signal and a predicted signal characteristic associated with the particular candidate location. The processor is further configured to: determine a location of the mobile device; and determine the predicted signal characteristic; where the predicted signal characteristic is a predicted distance between the mobile device and the particular candidate location based on the location of the mobile device and the particular candidate location; and where the characteristic determined from the signal is a distance based on a time difference of arrival between the signal and at least one other signal from at least one other base station.

Also or alternatively, implementations of such a mobile device may include one or more of the following features. The processor is further configured to send, via the transceiver, an indication of the particular candidate location to the location server. The processor is further configured to determine a location of the mobile device, and the indication of the particular candidate location includes an indication of the characteristic determined from the signal and the location of the mobile device. The indication of the particular candidate location comprises a likelihood value for each of the two or more candidate locations. The indication of the particular candidate location comprises a ranking of the two or more candidate locations.

Also or alternatively, implementations of such a mobile device may include one or more of the following features. The processor is configured to receive the BSID of the base station and the two or more candidate locations of the base station as part of a base station almanac.

An example of a method of identifying an actual location of a base station includes: transmitting, from a location server to a disambiguating mobile device, a base station identifier (BSID) of the base station and two or more candidate locations of the base station; and receiving, at the location server from the disambiguating mobile device, an indication of the actual location of the base station from among the two or more candidate locations.

Implementations of such a method may include one or more of the following features. The further includes: receiving, at the location server, base station location information from a plurality of mobile devices; and determining, at the location server, the two or more candidate locations of the base station from the base station location information received from the plurality of mobile devices. The base station location information received from a respective mobile device of the plurality of mobile devices includes a distance from the respective mobile device to the base station, and a location of the respective mobile device. The method further includes updating location information stored on the location server based on the indication. Updating the location information is performed in response to receiving the indication of the actual location of the base station from more than a threshold number of mobile devices. The method further includes transmitting the actual location of the base station and the BSID to a different mobile device. The method further includes transmitting a time bias of the base station to the disambiguating mobile device.

An example of a location server includes: a memory; a communications subsystem configured to receive signals from a base station and to send signals to the base station for communication with a mobile device; and a processor operably coupled to the memory and to the communications subsystem, where the processor is configured to: transmit, to a disambiguating mobile device via the communications subsystem, a base station identifier (BSID) of the base station and two or more candidate locations of the base station; receive, from the disambiguating mobile device via the communications subsystem, an indication of an actual location of the base station from among the two or more candidate locations; and update, based on the indication of the actual location of the base station, location information stored in the memory.

Implementations of such a location server may include one or more of the following features. The processor is configured to update the location information in response to receiving the indication of the actual location of the base station from more than a threshold number of mobile devices. The processor is further configured to transmit the actual location of the base station and the BSID to a different mobile device. The processor is further configured to: receive, via the communications subsystem, base station location information from a plurality of mobile devices; and determine the two or more candidate locations of the base station from the base station location information received from the plurality of mobile devices. The processor is further configured to transmit a time bias of the base station to the disambiguating mobile device.

### BRIEF DESCRIPTION OF THE DRAWINGS

Non-limiting and non-exhaustive examples of methods and systems are described with reference to the following figures. Identical reference numerals refer to like parts throughout the various figures. The figures may not be drawn to scale.

FIG. 1 is a simplified representation of a first scenario where locations of mobile devices may give rise to an erroneous estimation of a base station's location.

FIG. 2 is a simplified representation of a second scenario where locations of mobile devices may give rise to an erroneous estimation of a base station's location.

FIG. 3 is a simplified diagram of an environment including a wireless communication network and a satellite positioning system.

FIG. 4 is a block diagram of a location server shown in FIG. 3.

FIG. 5 is a block diagram of a mobile device shown in FIG. 3.

FIG. 6 is a call flow diagram.

FIG. 7 is a flow diagram of a method of operating a mobile device.

FIG. 8 is a flow diagram of a method of operating a mobile device

FIG. 9 is a flow diagram of a method of operating a location server.

FIG. 10 is a flow diagram of a method of operating a location server.

FIG. 11 is a simplified representation of a scenario where a mobile device receives multiple candidate locations and uncertainties associated with each candidate location.

### DETAILED DESCRIPTION

Example techniques and devices are presented herein for determining base station locations and time biases and/or updating base station location information stored at a location server. For example, a location server may send multiple candidate locations and time biases of a base station to a disambiguating mobile device. The disambiguating mobile device determines which candidate location and time bias is most likely an actual location of the base station based on a location of the mobile device and a range to the base station. The mobile device location may be an estimated location and the range may be determined from one or more signals received from the base station by the mobile device. The mobile device may send information to the location server indicating which of the candidate locations is most likely the actual location of the base station. The location server may update locally-stored location data and time bias data for the base station, e.g., in a base station almanac (BSA). One or more of the techniques discussed may provide for faster, more reliable base station location updating than conventional techniques. Also, while the discussion herein often refers to determining which candidate location is most likely the actual location of the base station, the discussion may be applicable to instances of only two candidate locations and thus which candidate location is more likely to be the actual location of the base station, but the term “most” is still used for simplicity.

A base station has not only a location, but also has a time bias relative to a global time, such as the time used by a global positioning system (GPS), sometimes referred to as a time of arrival bias. The time bias for a base station is unique and is different for each base station. This is, in part, because the time bias is caused by the amount of time it takes for a signal to travel from the base station's antenna to a processor of the base station. The distance between the antenna and the processor differs for each base station, making the time bias of each base station different. This time bias may be determined using a technique referred to as “forward link calibration” (FLC). Time bias values, or FLC values, may be determined for pairs of base stations in a communication network, such as described in U.S. patent application Ser. No. 14/146,682, filed on Jan. 2, 2014, and titled “Determination of Differential Forward Link Calibration in LTE Networks for Positioning,” the contents of which are incorporated herein by reference. Throughout the present disclosure, the terms “base station location,” “candidate location,” and “location” are used to include not only the three-dimensional locations, but also the time biases of the associated base station. Thus, locations may be considered four-dimensional positions (x, y, z, t). For clarity, the disclosure and the figures describe base station locations as two-dimensional positions, but in practice all four dimensions may be included.

The locations of base stations of a wireless network may not be known a priori to a location server. Instead, the location of a particular base station may be determined based on information provided by mobile devices that communicate with the base station. The information provided by the mobile devices is referred to as “crowdsourced data.” The crowdsourced data may be, for example, range information, such as a measurement of the distance between a particular mobile device and the base station. The range information may be, for example, a time delay between the time a signal was sent by the base station and the time the signal was received by the mobile device. The crowdsourced data may also include information about the current mobile device location obtained from alternative means, such as from a satellite positioning system. In an environment where mobile devices are relatively evenly distributed, multiple range measurements and mobile device locations may be sent to the location server and used to calculate the location of a base station using multilateration techniques.

The inventors have recognized and appreciated that there are distributions of mobile devices that result in errors when attempting to determine the location of a base station. For example, in situations where, instead of being well-distributed throughout the region near a base station, mobile devices are distributed in a straight line, or nearly so, or the mobile devices are confined to a small area within the region served by the base station, the multilateration techniques of the location server may become slow, give erroneous results, or give no results at all.

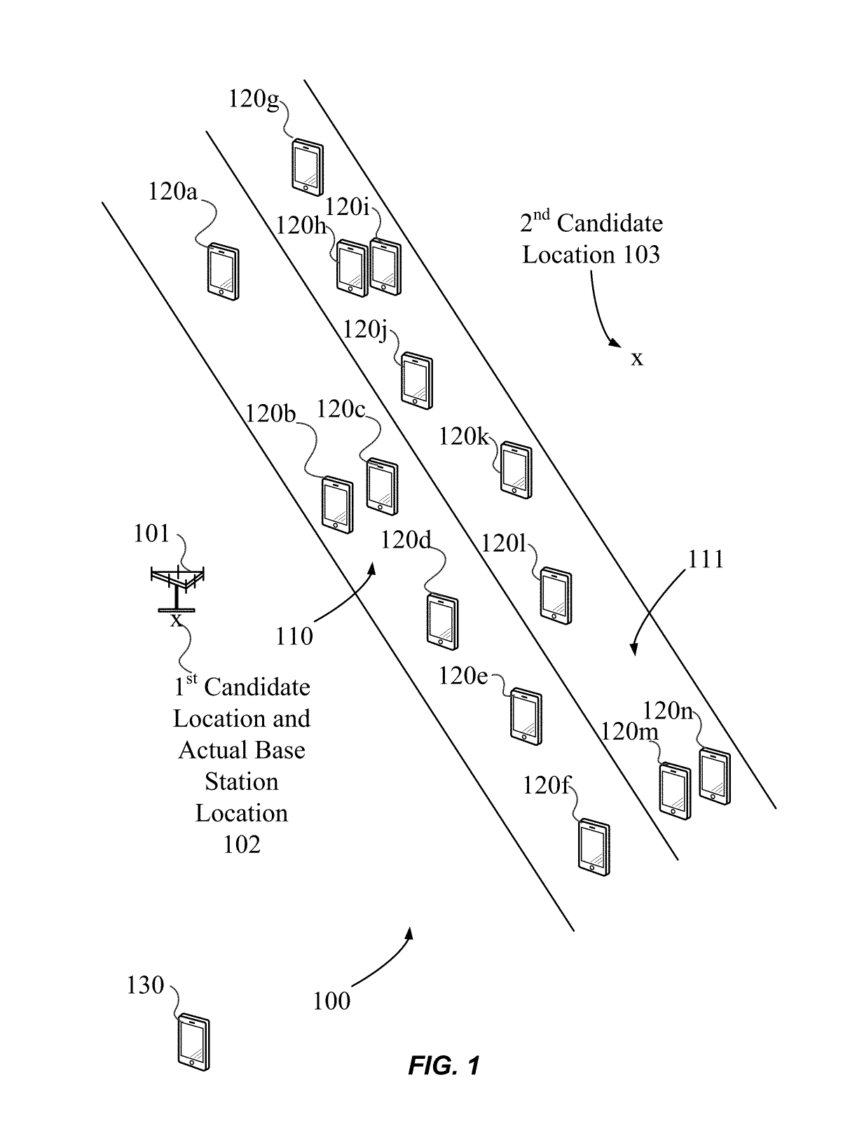

FIG. 1 shows a first scenario where the locations of mobile devices may give rise to an erroneous and/or delayed estimation of a base station's location. A region 100 serviced by the base station 101 includes mobile devices 120a-120n (referred to collectively as mobile devices 120). The mobile devices 120 are approximately-linearly disposed, being disposed approximately on a straight line due to the fact that the mobile devices 120 are in vehicles (not shown) that are on a heavily-travelled road, such as a highway or expressway with a lane 110 for traffic travelling in a first direction and a lane 111 for traffic travelling in a second direction. Being disposed approximately on a straight line means that the mobile devices 120 are disposed near enough to a straight line such that when a multilateration calculation is performed using data collected by the mobile devices 120 from the base station 101, more than one location will be determined to be a candidate location for the base station 101. A first candidate location 102 for base station 101 is the actual location of the base station 101. A second candidate location 103 for the base station 101 is a candidate location that is located at a position that is approximately at a mirror-image location of the candidate location 102 relative to the line of mobile devices 120. This mirror effect results from using range information to determine the candidate location 103. The actual location 102 and the candidate location 103 are possible solutions, possibly equally so, to the multilateration process.

In situations like that shown in FIG. 1, some conventional location servers use multilateration techniques that select a more probable location without considering the fact that the mirrored candidate location 103 may be erroneously selected. Other conventional location servers wait until additional crowdsourced data from one or more mobile devices that are not aligned with the mobile devices 120 (e.g., mobile device 130 in FIG. 1) provide sufficient data to disambiguate the two candidate locations. Passively waiting for additional data can take time and result in a slow process of building a database of base station locations. On the other hand, actively transmitting multiple candidate locations to a mobile device for disambiguation results in the database of base station locations being built more quickly.

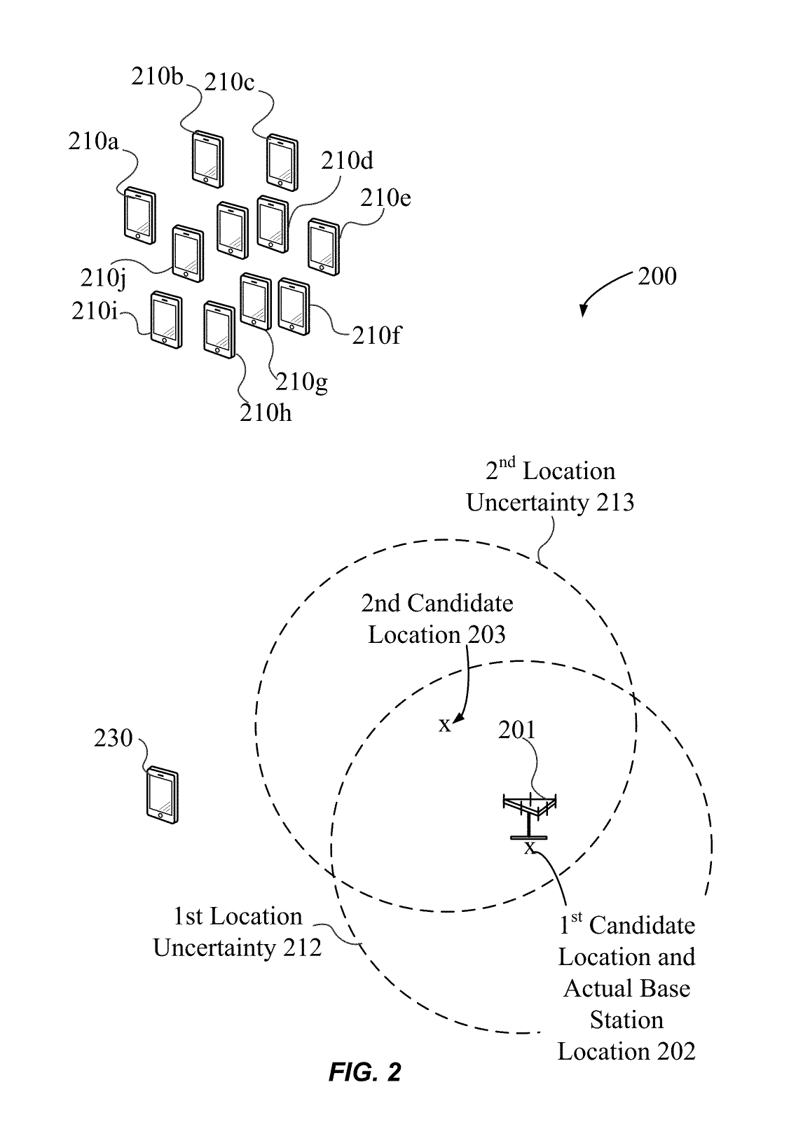

FIG. 2 shows a second scenario where the locations of mobile devices may give rise to an erroneous and/or delayed estimation of a base station's location. A region 200 serviced by a base station 201 includes mobile devices 210a-210j (referred to collectively as mobile devices 210). The mobile devices 210 are clustered together at a location that is some distance from the actual base station location 202. Such a distribution of mobile devices 210 may arise, for example, when there is a small remote town or a single building located in a remote location. In this second scenario illustrated in FIG. 2, when data from signals received by the mobile devices 210 are used to determine base station location, a candidate location (such as first candidate location 202 or second candidate location 203) may have a corresponding uncertainty (such as 1^{st} location uncertainty 212 and 2^{nd} locating uncertainty 213, respectively) that is unacceptably large. That is, the location uncertainties 212, 213 (a range from, or a region about, the candidate locations 202, 203, respectively, within which the actual base station location 202 may be) may be too large for the determined base station location to be useful (e.g., for use in reverse positioning of a mobile device to a desired degree of accuracy). Consequently, when a multilateration calculation is performed, it is possible that more than one candidate location, e.g., first candidate location 202 and second candidate location 203, will be selected and the location server may not be able to determine with certainty which candidate location is more likely to be the actual base station location 202. Some conventional location servers wait until additional crowdsourced data from one or more mobile devices that are not aligned with the mobile devices 210 (e.g., mobile device 230 in FIG. 2) provide sufficient data to disambiguate the two candidate locations. Passively waiting for additional data can take time and result in a slow process of building a database of base station locations. On the other hand, actively transmitting multiple candidate locations to a mobile device for disambiguation results in the database of base station locations being built more quickly.

The scenarios shown in FIG. 1 and FIG. 2 may result in an erroneous determination of base station location and/or a slow-down in the process of determining the base station location. Base station locations are used to calculate mobile device positions and thus it is desirable to calculate and provide base station location information to mobile devices quickly and accurately.

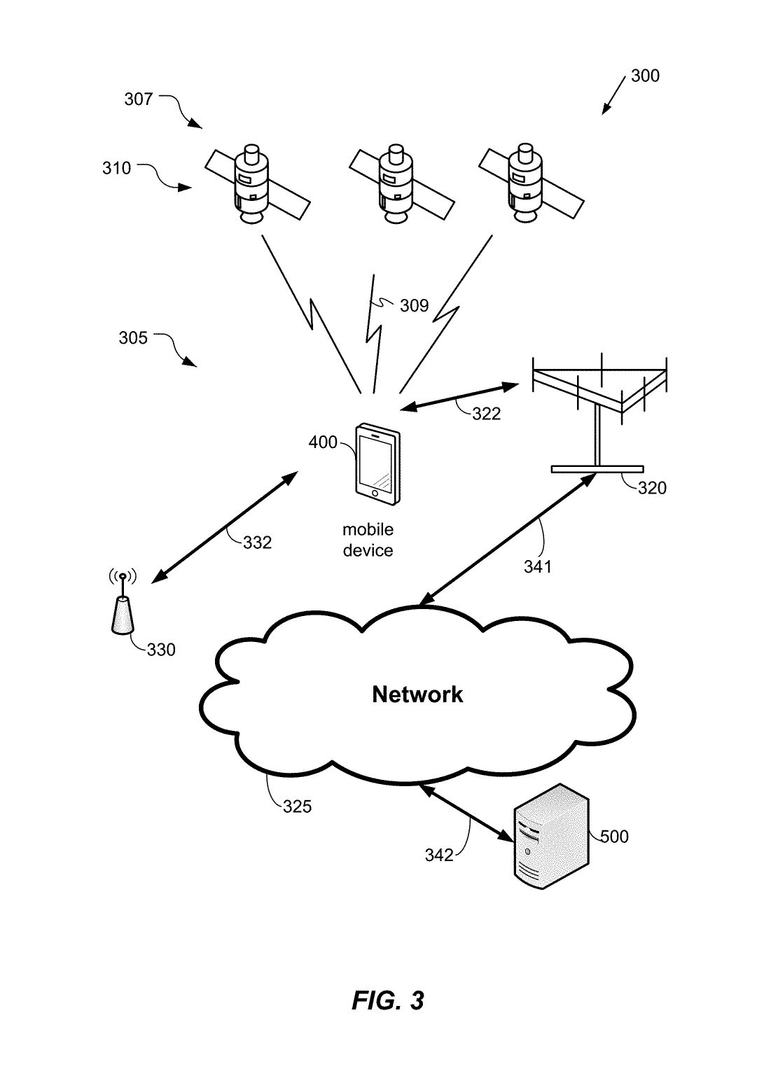

Referring to FIG. 3, a simplified diagram is shown of an example environment 300 including a wireless communication network 305 and a satellite positioning system (SPS) 307 including SPS satellites 310. The environment 300 is an example, and other environment configurations may be used. The SPS may be a Global Positioning System (GPS), Global Navigation Satellite System (GNSS), Galileo, GLONASS, Beidou (Compass), etc. The SPS satellites 310 may be referred to as satellites, space vehicles (SVs), etc. The wireless communication network 305 includes a mobile device 400, a base station 320, a local transceiver 330, a network 325, and a server 500. The mobile device 400 may transmit radio signals to, and receive radio signals from, one or more base stations in the wireless communication network 305. For example, the mobile device 400 may communicate with a cellular communication network by transmitting wireless signals to, or receiving wireless signals from, the base station 320 which may include a wireless base transceiver station (BTS), a Node B, an evolved NodeB (eNB), etc., over wireless communication link 322. Similarly, mobile device 400 may transmit wireless signals to, or receive wireless signals from, the local transceiver 330 over wireless communication link 332. The local transceiver 330 (which may also be considered a “base station” herein) may comprise a Wi-Fi access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network or ZigBee® network) or a cellular network (e.g. an LTE network or other wireless wide area network such as those discussed in the next paragraph). These are examples of networks that may communicate with a mobile device over a wireless link, and claimed subject matter is not limited in this respect. Further, while only one base station 320, one local transceiver 330, and one server 500 are shown, more than one base station and/or more than one local transceiver and/or more than one server may be used.

Examples of network technologies that may support wireless communication link 322 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Base station 320 may comprise deployments of equipment providing subscriber access to a wireless telecommunication network for a service (e.g., under a service contract). Here, a transceiver of the base station 320 may perform functions of a cellular base station in servicing subscriber devices within a cell determined based, at least in part, on a range at which the base station 320 is capable of providing access service. Examples of radio technologies that may support wireless communication link 322 are IEEE 802.11, Bluetooth (BT) and LTE.

The base station 320 and the local transceiver 330 may communicate with the server 500 over the network 325. Here, the network 325 is communicatively coupled to the base station 320, the local transceiver 330, and the server 500 and comprises wireless links 341 and wired links 342 to enable communication between the base station 320 and the local transceiver 330 and the location server 500. The network 325 may utilize Internet Protocol (IP) or other communication protocols to convey data packets. The network 325 comprises infrastructure capable of facilitating communication between mobile device 400 and location server 500 through local transceiver 330 and/or base station 320. The network 325 may comprise cellular communication network infrastructure such as, for example, a base station controller or packet based or circuit based switching center (not shown) to facilitate mobile cellular communication with mobile device 400. Also or alternatively, the network 325 may comprise local area network (LAN) elements such as wireless LAN access points (WLAN APs), routers and bridges and may include or have links to gateway elements that provide access to wide area networks such as the Internet. The network 325 may comprise multiple networks (e.g., one or more wireless networks and/or the Internet).The network 325 may include one or more serving gateways or Packet Data Network gateways.

The mobile device 400 may have circuitry and processing resources capable of obtaining location-related measurements (e.g., for signals received from SPS satellites 310, base station 320 and/or local transceiver 330) and computing a position fix or estimated location (e.g., an a priori location) of mobile device 400 based on these location-related measurements. Location-related measurements obtained by mobile device 400 may include measurements of SPS signals 309 received from SPS satellites 310, signals (such as signals over wireless communication link 322 and/or wireless communication link 332) received from terrestrial transmitters fixed at known locations (e.g., such as base station 320). Location-related measurements obtained by mobile device 400 may be transferred to the location server 500, and the location server 500 may estimate or determine a location for mobile device 400 based on the measurements. Mobile device 400 or server 500 may obtain a location estimate for mobile device 400 based on these location-related measurements using any one of several known positioning methods such as trilateration or multilateration.

The server 500 may be any of a variety of server types. For example, the server 500 is preferably a location server such as an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) in network 325.

The location server 500 may be capable of providing positioning assistance data to mobile device 400. For example, positioning assistance data may include information regarding signals to be measured (e.g., signal timing), locations and identities of terrestrial transmitters, and/or timing and orbital information for SPS satellites 310. The server 500 may provide multiple candidate locations for the base station 320 as part of the positioning assistance data. The mobile device 400, as discussed further below, is configured to determine which candidate location is more or most likely the actual location of the base station 320 and inform the server 500 accordingly, and/or to provide information from which the server 500 make this determination. The server 500 is configured to update a database based on the determination of which candidate location is correct (whether determined by the mobile device 400 or the server 500).

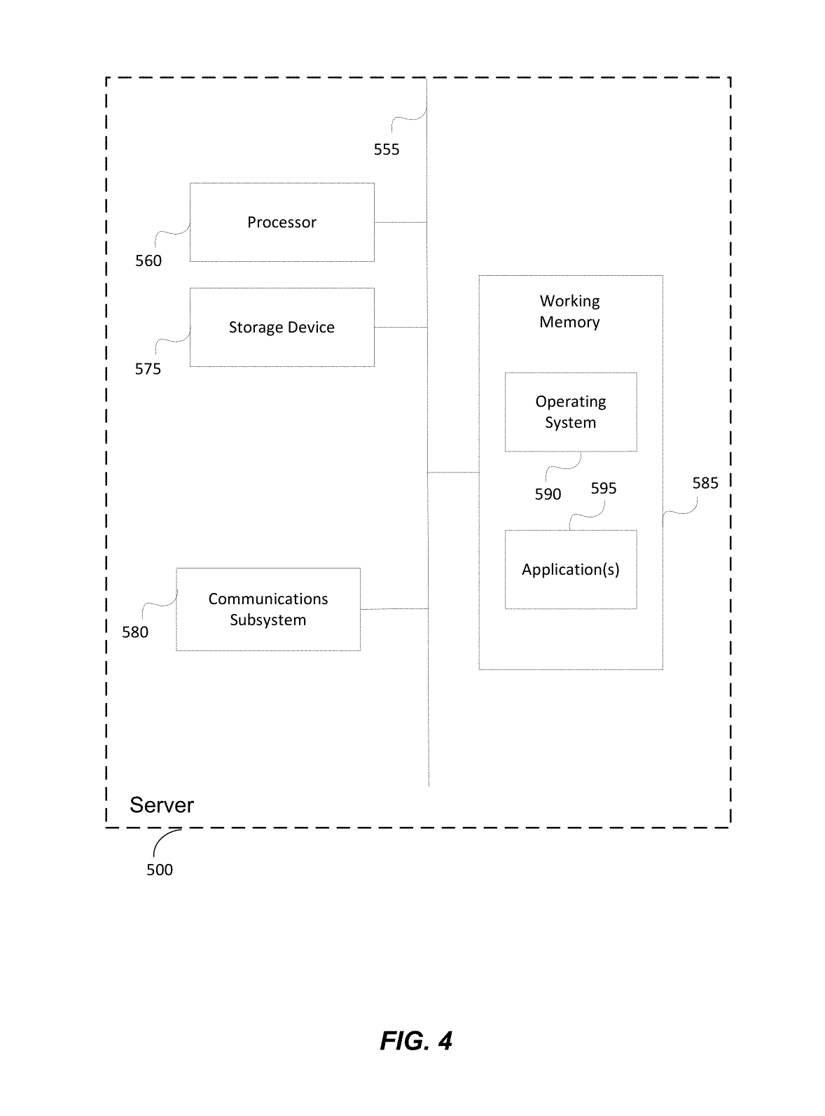

Referring to FIG. 4, an example of the location server 500 configured to implement techniques for updating base station location information is shown. Other configurations of the location server 500 may, however, be used.

The location server 500 comprises hardware elements that are communicatively coupled via a bus 555 (though the hardware elements may otherwise be in communication, as appropriate). The hardware elements include a processor 560, including without limitation one or more general-purpose processors and/or one or more special-purpose processors (such as digital signal processing chips, graphics acceleration processors, and/or the like). The location server 500 may further include (and/or be in communication with) one or more non-transitory storage devices 575, which may comprise, without limitation, one or more physical entities such as a random access memory (“RAM”) and/or a read-only memory (“ROM”). Such storage devices may be configured to implement any appropriate data stores, including without limitation, various file systems, database structures, and/or the like. Additionally, the location server 500 may utilize remote storage devices that are not a part of the location server 500. Such remote storage devices may be accessible via the network 325 to which the location server 500 communicates via a communications subsystem 580.The communications subsystem 580, which can include a modem, a network interface card (wireless or wired), or any other network interface. The communications subsystem 580 may permit data to be exchanged with the network 325 (such as the network described below, to name one example) and other computer systems.

The location server 500 also includes a working memory 585, which may store an operating system 590, device drivers, executable libraries, and/or other code, such as one or more application programs 595, which may comprise computer programs for implementing methods, and/or configure systems, provided by other embodiments, as described herein.

Storage device 575 may store, for example, base station location information. Base station location information includes base station identification information and candidate location information. The base station location information may be stored in a data structure such as a table or a database. In some examples it is stored as a base station almanac (BSA). The BSA indicates locations and identities of base stations (e.g., cellular transceivers and/or local transceivers) in a particular region, and may include information descriptive of signals transmitted by a base station such as transmission power and signal timing. In situations where a base station's location includes two or more candidate locations, the mobile device 400 may use the aforementioned measurements to identify the candidate location that is most likely to be the actual location of the base station.

Processor 560 is configured to obtain the base station location information by determining base station location information and/or by receiving base station location information from mobile device 400 (and/or other mobile devices). Processor 560 may be configured to perform trilateration on information provided by mobile devices, e.g., signal strengths, corresponding base stations from which the signals are received by the mobile devices, locations of the mobile devices when the signals are received, to determine base station locations. Also or alternatively, base station locations may be determined by mobile devices and provided to server 500. As discussed above, server 500 and/or mobile device 400 may determine that there are two or more possible locations for a base station. This may result from using range information received from multiple mobile devices that are approximately linearly disposed or that are disposed close together. For example, server 500 and/or mobile device 400 may determine that more than one candidate location of a base station has a likelihood above a threshold likelihood value of being the actual location of the base station. In this situation, server 500 may store the multiple possible locations for the base station as candidate locations for the base station.

Server 500 may be configured to send the base station candidate locations to mobile devices. Server 500 may send the candidate locations to mobile devices as part of assistance data for use in the mobile devices determining their respective positions, e.g., by trilateration using signals received from base stations and the locations of the base stations. The server 500 may be configured to send the assistance data to a disambiguating mobile device to determine the actual location of a base station, and to other (different) mobile devices, e.g., for use in determining the locations of the other mobile devices. The assistance data may include a base station identifier (BSID) and the candidate locations associated for the base station corresponding to the BSID. The assistance data may be part of a base station almanac. Server 500 may send the assistance data to the mobile devices in response to requests from the mobile devices, or without being requested (e.g., periodically to mobile devices in communication with base stations for which assistance data are provided). The location server 500 may then receive an indication from at least one of the mobile devices indicating which of the candidate locations is likely to be the actual location of the base station. The location server 500 may then update the candidate locations stored on the location server 500 (e.g., in the BSA) based on the information received from the at least one mobile device. For example, the location server 500 may remove, from the almanac, incorrect candidate locations. Incorrect candidate locations may include candidate locations that are determined not to be the actual location of the base station. In this way, the location server 500 updates the base station location information stored in the BSA such that only a single location is included. It may be beneficial for the location server 500 to update the BSA in response to receiving indications from multiple mobile devices rather than a single mobile device 400. For example, the location server 500 may not update the BSA until a threshold number of mobile devices, e.g., 2, 5, 10, or other number, have indicated that a particular candidate location is (or is not) the actual location of the base station.

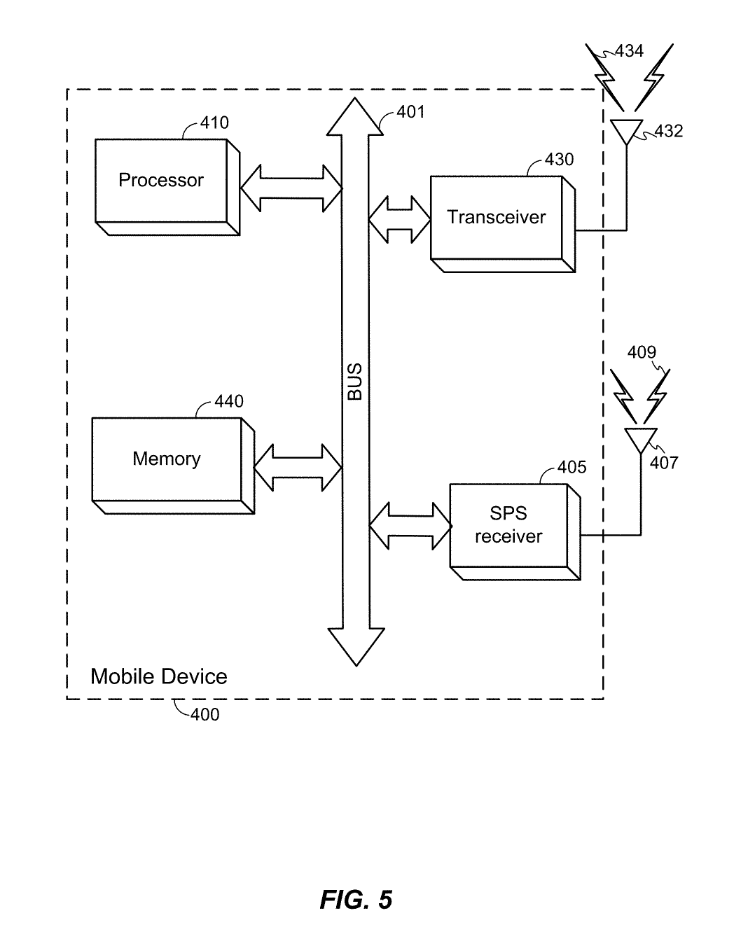

FIG. 5 is a block diagram of an example of mobile device 400, although other configurations of the mobile device 400 may be used. The mobile device 400 may include or implement the functionality of one or more of various mobile communication and/or computing devices such as a tablet, a smartphone, a portable navigation device, a network-enabled wrist watch, etc., whether presently existing or developed in the future. The mobile device 400 includes a processor 410 (or processor core), a memory unit 440, a transceiver 430, an antenna 432, an SPS receiver 405, and an SPS antenna 407. While only one processor 410 and one memory unit 440 are shown in FIG. 4, more than one of either or both of these components could be included in the mobile device 400. For example, the processor 410 may include one or more of central processing units (CPUs), digital signal processors (DSPs), field programmable gate arrays (FPGAs), or application specific integrated circuits (ASICs).

The processor 410, memory unit 440, transceiver 430 and SPS receiver 405 are communicatively coupled to each other via a bus 401. Here, the mobile device 400 is illustrated as having a single transceiver 430 and a single antenna 432 for receiving wireless signal 434. However, the mobile device 400 can alternatively have multiple transceivers 430 and multiple antennas 432 to support multiple communication standards such as Wi-Fi, CDMA, Wideband CDMA (WCDMA), Long Term Evolution (LTE), Bluetooth® short-range wireless communication technology, etc. The mobile device 400 can communicate with one or more base stations via the transceiver 430.

The transceiver 430 is configured to receive signals from and send signals to base stations, such as base station 320, over a wireless network via the antenna 432. The transceiver 430 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The SPS receiver 405 is configured to receive SPS signals 409 (e.g., from SPS satellites 310, see FIG. 3) via SPS antenna 407. The SPS receiver 405 can communicate with a single SPS (e.g., a global navigation satellite system (GNSS)) or multiple such systems. The SPS receiver 405 is configured to process, in whole or in part, the SPS signals 409 to determine the location of the mobile device 400. The processor 410 and memory unit 440, and/or specialized processor(s) (not shown) may also be utilized to process the SPS signals 409, in whole or in part, and/or to calculate the location of the mobile device 400, in conjunction with SPS receiver 405.

The memory unit 440 is a non-transitory processor-readable storage medium (or media) that stores processor-readable instructions configured to cause a processor to perform functions as discussed herein. Media that can make up the memory unit 440 include, but are not limited to, random access memory (RAM), read-only memory (ROM), FLASH, disc drives, etc. In general, the instructions stored by the memory unit 440 are executed by the processor 410. Thus, the memory unit 440 is a processor-readable memory that stores software (programming code, instructions, etc.) configured to cause the processor 410 to perform the functions described herein (although the description may read that the software performs the functions). Alternatively, one or more functions of the mobile device 400 may be performed in whole or in part in hardware.

The mobile device 400 is configured to determine a current location of the mobile device 400 using one or more base station signals and assistance data. To determine the current position of the mobile device 400 using one or more base station signals, the mobile device 400 may perform trilateration using measurements of base station signals and assistance data. The mobile device 400 may obtain the assistance data from a base station, such as base station 320. The transceiver 430 may be used to send a request for assistance data to the server 500 via the base station. The assistance data may include locations of base stations, e.g., base stations disposed near the mobile device 400 (e.g., base stations near the base station that is in communication with the mobile device 400).

The assistance data obtained by the mobile device 400 may include two or more candidate locations for a base station and a base station identity (BSID), sent from the location server 500 via a base station. The assistance data may be part of a base station almanac and the BSID identifies the base station corresponding to the candidate locations for the base station, e.g., supplied by the location server 500. The candidate locations received by the mobile device 400 may be candidate locations for the base station being used to facilitate communication between the mobile device 400 and the location server 500, or for another base station. For example, the candidate locations may be for a base station that is near the base station being used to facilitate communication between the mobile device 400 and the location server 500. Further, candidate locations may be provided for more than one base station. To use the assistance data to determine the position of the mobile device 400, the mobile device 400 may determine which of the candidate locations is more likely to be the actual base station location.

The mobile device 400 is preferably configured to determine which of multiple candidate locations of a base station is more, or most, likely to be the actual location of the base station. To determine which candidate base station location is more likely the actual location of the base station, the processor 410 can estimate the current position of mobile device 400, determine an actual range (distance) from mobile device 400 to the base station for which candidate locations have been received, determine expected ranges (distances) from mobile device 400 to the candidate locations, and compare the actual range to the expected ranges.

The processor 410 may be configured to determine a characteristic from a signal received, via the transceiver 430, from a base station identified by the BSID and to select a particular location from two or more candidate locations based on the characteristic determined from the signal. The processor 410 may be configured to select, as the particular candidate location, the candidate location that has a greatest correlation between the characteristic determined from the signal and a predicted signal characteristic associated with the particular candidate location. For example, the processor 410 may determine a distance from the mobile device 400 to the base station as the characteristic determined from the signal, determine a predicted signal characteristic for each candidate location, and compare the determined characteristic with each predicted signal characteristic. For example, the processor 410 may compare determined and predicted distances. As an example, the processor 410 may determine the distance from the mobile device 400 to the base station based on a time difference of arrival (TDOA) between the signal and at least one other signal from at least one other base station. As another example, the processor 410 may determine the distance from the mobile device 400 to the base station using a received signal strength indication (RSSI) of a signal from the base station and a known transmit power of the signal from the base station.

Processor 410 may be configured to determine the position of mobile device 400 using one or more techniques that are independent of base station locations. For example, the mobile device 400 can estimate the position of mobile device 400 using trilateration based on information obtained from SPS satellites, using a prior known location and determining motion from inertial navigation sensors (e.g., accelerometers, gyroscopes, a magnetometer), and/or techniques for using map constraint data obtained from a map server to constrain the location of mobile device 400 to certain locations. One or more of these techniques may be used to determine position estimate of the mobile device 400.

Further, the mobile device 400 may use other signals from a base station to determine an actual range from the mobile device 400 to any base station, e.g., base station 320, for which candidate locations have been received. For example, a positioning reference signals (PRS) or other positioning-related signal(s) transmitted by the base station 320 may be used by the processor 410 to determine a travel time, i.e., a time between when the signal was sent from the base station 320 and when the signal was received by the transceiver 430. The processor 410 may convert this travel time into a distance using the speed of light, with the distance being the actual range from the base station to the mobile device 400.

The mobile device 400 is configured to determine expected ranges from mobile device 400 to the candidate locations. For example, processor 410 can use coordinates of the determined location of mobile device 400 and coordinates of the candidate locations of base station 320 to determine an expected range from mobile device 400 to each of the candidate locations. Processor 410 may use any known technique for determining the expected ranges such as a linear distance formula of

R=\sqrt{(x₂−x₁)²+(y₂−y₁)²+(z₂−z₁)²}

where R is an expected range, (x₁, y₁, z₁) are coordinates of mobile device 400, and (x₂, y₂, z₂) are coordinates of a candidate location of base station 320.

The mobile device 400 is configured to determine which expected range better (or best) matches the actual range to base station 320 to determine which of the candidate locations is more likely to correspond to the actual location of base station 320. For example, processor 410 may compare the calculated expected ranges associated with the candidate locations to the actual range and determine (e.g., select) as the actual location of base station 320 the candidate location corresponding to the expected range that better (or best for more than two candidate locations) matches the actual range. A threshold correspondence between an expected range and the actual range may be imposed by processor 410 before processor 410 will determine a candidate location as the actual base station location. For example, a difference between the actual range and the expected range may need to be less than a threshold difference, or the actual range may need to be within a threshold percentage of the expected range, before processor 410 will determine that the candidate location corresponding to the expected range is the actual base station location. Also or alternatively, mobile device 400 may provide information (e.g., raw measurement information (SPS and/or base station signals), mobile device location, etc.) from which server 500 can determine the actual and expected ranges from mobile device 400 to base station 320 and the candidate locations, and sever 500 (e.g., processor 560) may determine which candidate location is the actual base station location.

The processor 410 may send to the location server 500, via the transceiver 430, the antenna 432, and the base station 320, an indication of which of the candidate locations 102, 103 more likely corresponds to the actual location 102 of the base station. That is, the processor 410 may send an indication of the particular candidate location selected by the processor 410, as discussed above, to the location server 500. For example, the processor 410 may send an indication of the characteristic of the base station signal (e.g., the distance from the base station to the mobile device 400) determined by the processor 410 and the location of the mobile device 400 to the location server 500. As another example, the processor 410 may send indications of received candidate locations with corresponding indications of whether the candidate location is the actual base station location or not. For example, processor 410 may send a binary “1” associated with the candidate location that is determined to be the actual base station location and send a binary “0” associated with any candidate location that is determined not to be (or not more/most likely to be) the actual base station location. This technique is an explicit indication of which candidate location is most likely the base station location. It is not necessary that the processor 410 send an indication for every candidate location. For example, the processor 410 may send a single bit indicating that a particular candidate location is most likely the location of the base station without sending an indication for the other candidate locations. In this case, it is implicit that the other candidate locations are not the base station location. Rather than indicating which candidate location is most likely the location of the base station, the processor 410 may send an indication of which candidate locations are most likely not the base station location. In this case, the location server 500 may user this information to reject these candidate locations without necessarily identifying one candidate location that is most likely the base station location. If the location server 500, based on such indications, reduces the number of candidate locations for a base station to a single candidate location, then the indications from processor 410 have implied that the one remaining candidate location is likely the actual base station location. This technique is an implicit indication of which candidate location is most likely the base station location.

Alternatively, the candidate location disambiguation information may include a likelihood or probability that each candidate location corresponds to the actual location of the base station. For example, if there are three candidate locations sent to the mobile device 400 by the location server 500, the mobile device 400 may send the location server a list of three numbers: {0.2, 0.7, 0.1}, indicating that the first candidate location has a 20% likelihood of being the actual location of the base station, the second candidate location has a 70% likelihood of being the actual location of the base station, and the third candidate location has a 10% likelihood of being the actual location of the base station. The likelihoods for each candidate location may be calculated in any number of ways. The likelihood that a candidate location corresponds to the actual location of the base station may be based on an uncertainty in the range to the base station, as determined by the mobile device, and/or an uncertainty of the candidate positions, which may be received from the base station along with the candidate positions themselves.

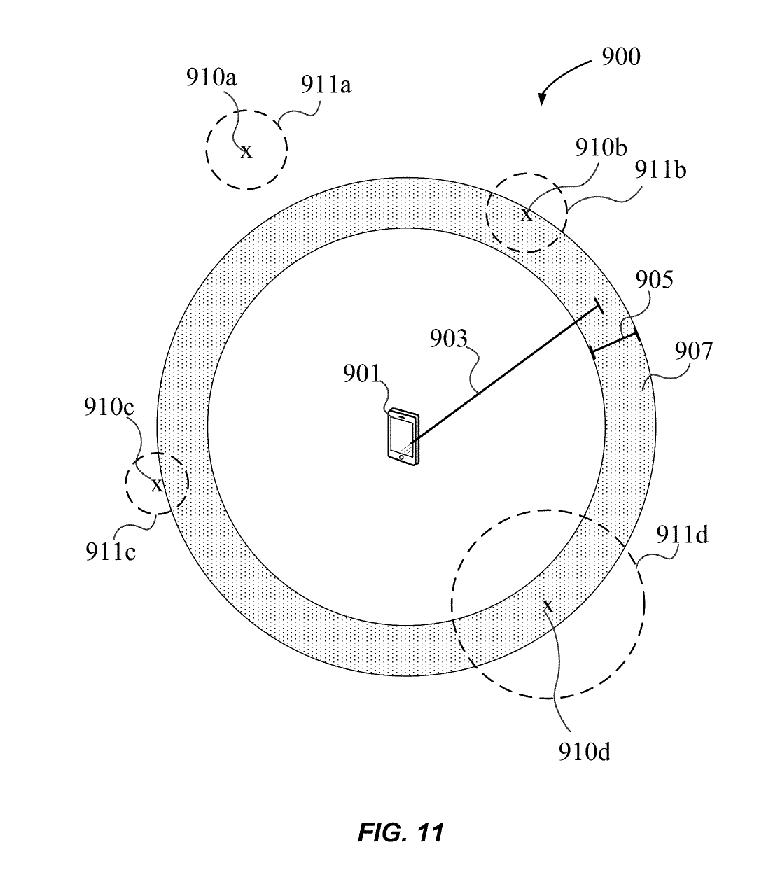

FIG. 11 is a simplified representation of a scenario 900 where a mobile device 901 receives four candidate locations 910a-d for a base station (not shown) and calculates a likelihood for each candidate location. The mobile device 901 also receives four uncertainty values 911a-d, each uncertainty value associated with a candidate location 910a-d. Thus, graphically, the candidate locations 910a-d and uncertainty values 911a-d are illustrated as circles with a radii equal to the corresponding uncertainty value 911a-d centered at the corresponding candidate location 910a-d. The mobile device 901 determines a range 903 to the base station using known techniques. The range 903 is associated with a range uncertainty 905, also determined by the mobile device 901. Thus, graphically, the range 903 and range uncertainty 905 are illustrated as an annulus 907 of possible locations of the base station.

In FIG. 11, the candidate locations 910a-d that are located near the center of the annulus 907 and have a low uncertainty value 911a-d are more likely to be the actual location of the base station. Thus, one technique for calculating the likelihood that a particular candidate location is the actual base station location is to calculate the ratio of the area associated with the uncertainty value 911a-d that overlaps with the annulus 907 to the total area associated with the uncertainty value 911a-d. For example, the first candidate location 910a has zero likelihood of being the actual base station location because the candidate location 910a is too far from the range 903 for the area associated with uncertainty value 911a to overlap with annulus 907. The second candidate location 911b has a ratio of about 50% because about half of the area associated with uncertainty value 911b overlaps with annulus 907. The third candidate location 911c has a ratio of about 33% because about one-third of the area associated with uncertainty value 911c overlaps with annulus 907. The fourth candidate location 911d has a ratio of about 25% because about one-third of the area associated with uncertainty value 911d overlaps with annulus 907. The above ratios may be normalized so that they sum to unity in order to convert the ratios to likelihoods. The resulting likelihoods for the example candidate locations 910a-d of FIG. 11 are, respectively, 0%, 46%, 31% and 23%. Note that, even though candidate location 910d is centered exactly at the center of annulus 907 (i.e., the distance from the mobile device 901 to the candidate location 910d is equal to the range 903), it is not the most likely candidate location because the uncertainty value 911d is large relative to uncertainty values 911a-c.

Also or alternatively, the candidate location disambiguation information may include a ranking of candidate locations, indicating an order of which candidate location is most likely to be the actual location of the base station down to the candidate location that is least likely to be the actual location of the base station. For example, if there are three candidate locations sent to the mobile device 400 by the location server 500, the mobile device may send the location server a list of three integers: {2, 1, 3}, indicating that the second candidate location is most likely to be the actual location of the base station, the first candidate location is the second most likely candidate location to be the actual location of the base station, and the third candidate location is the third most likely (or least likely, in the case of three candidate locations) candidate location to be the actual location of the base station.

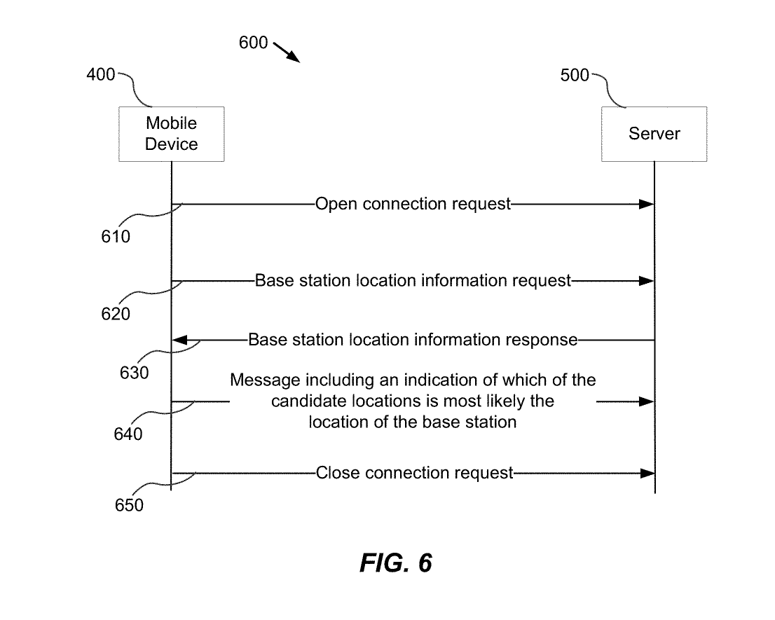

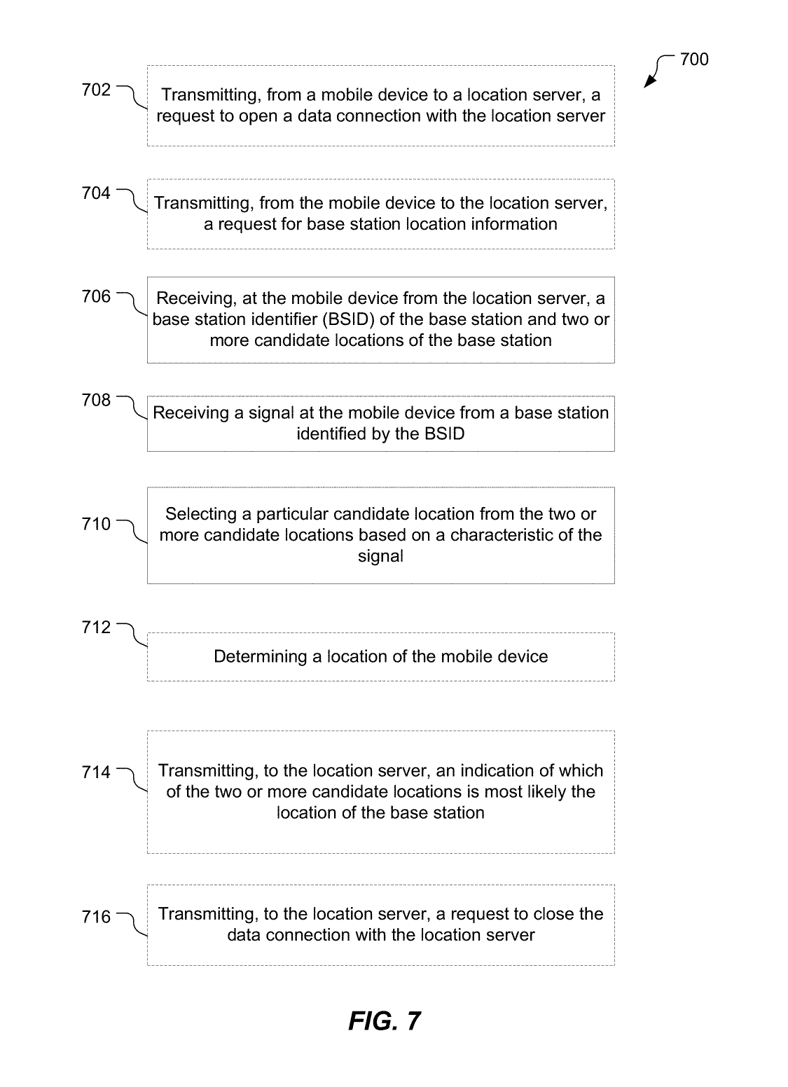

FIG. 6 is a call flow 600 illustrating messages that may be passed between the mobile device 400 and the location server 500 to disambiguate between multiple candidate base station locations. The mobile device 400 may be referred to, in this context, as a “disambiguating mobile device” because the mobile device determines which one of multiple candidate locations is most likely the actual location of a base station. The call flow 600 will be described in connection with FIGS. 7-10 below.

Referring to FIG. 7, with further reference to FIGS. 3-6, a method 700 of disambiguating between multiple candidate base station locations includes the stages shown. The method 700 is, however, an example only and not limiting. The method 700 can be altered, e.g., by having stages added, removed, rearranged, combined, performed concurrently, and/or having single stages split into multiple stages. For example, the stages of method 700 illustrated with dashed lines may be omitted.

At stage 702, the method 700 includes transmitting, to a location server, a request to open a data connection with the location server. For example, the request 610 may be an open connection request sent from the mobile device 400 to the server 500. The requested connection may be any connection suitable for wireless communicating between the mobile device 400 and the location server 500. The data connection may be an encrypted connection formed through a network that includes both wired and wireless components. For example, the connection may be a transport layer security (TLS) connection or a secure sockets layer (SSL) connection. As is the case with TLS and SSL, the connection between the mobile device 400 and the location server 500 may be an encrypted connection. Consequently, additional messages (not shown) may be used to establish a secure and authenticated connection. The open connection request 610 may not be necessary, e.g., if an open connection already exists between the mobile device 400 and the location server 500. Also or alternatively, the location server 500 may send an open connection request to the mobile device.

At stage 704, the method 700 includes transmitting, to the location server, a request for base station location information. For example, the request 620 may be a base station location information request sent from the mobile device 400 to the location server 500 after the connection is established. For example, request 620 may be an HTTP POST message. The request 620 may include information about the mobile device 400 that is intended for the location server. For example, the request 620 may include mobile device identification information, mobile device location information, and/or information indicating which base stations are near the mobile device 400.The request may include range information indicating distances from the mobile device 400 to one or more base stations. Alternatively, this range information may be in an independent message separate from the base station location information request. This range information may be used by the location server to determine base station location information, such as possible candidate locations. The request may also include information about which base stations are near the mobile device.

At stage 706, the method 700 includes receiving, from the location server, a base station identifier (BSID) of the base station and two or more candidate locations of the base station. The candidate locations may be sent from the location server in the form of a base station location information response 630 sent in response to the base station location information request 620. The base station location information response 630 may include candidate location information for one or more base stations. The BSID of the base station and the two or more candidate locations may be received as part of a base station almanac sent from the location server. The candidate locations may include global location information such as latitude, longitude and height information. Alternatively, the candidate locations may be indicated by non-global (local) information. For example, one or more of the candidate locations may be a location within a venue, such as a room within a building. The candidate locations may be provided in the response 630 responsive to the request 620. The candidate location information may include estimates of the base station location calculated using range information previously sent by other mobile devices, and may include multiple candidate locations for each of one or more individual base stations.

At stage 708, the method 700 includes receiving a signal at the mobile device from a base station identified by the BSID. For example, the signal received may be the signal that includes the BSID and the two or more candidate locations, or another signal from the base station.

At stage 710, the method 700 includes selecting a particular candidate location from the two or more candidate locations based on a characteristic of the signal. For example, this may comprise determining which of the two or more candidate location is most likely the actual location of the base station based on the signal received in stage 708. The processor 410 may determine an expected range to each candidate location and the actual range to the base station 320, compare the actual range to the expected ranges, and determine that the actual base station location is the candidate location corresponding to the expected range that best matches the actual range. The mobile device 400 may use information from the signal and/or may measure information of the signal that allows the mobile device 400 to determine information such as the range from the mobile device 400 to the base station 320. For example, the signal may include a positioning reference signal (PRS) or other signal transmitted by the base station that the mobile device can use to determine a time delay between when the signal was sent from the base station 320 and when the signal was received by mobile device. The signal may be of a known or indicated energy and the mobile device 400 may measure a received signal strength of the signal and determine a range from the mobile device 400 to the base station 320 based on the energy difference from transmission by the base station 320 to receipt by the mobile device 400.

At stage 712, the method 700 includes determining a location of the mobile device. For example, the processor 410 may determine a location estimate for the mobile device 400. The location estimate may be determined using location-related measurements as discussed above.

At stage 714, the method 700 includes transmitting, to the location server, an indication of which of the two or more candidate locations is most likely the location of the base station. The mobile device 400 may send this indication in a message 640 when multiple candidate locations were received from the server 500 and the mobile device 400 was able to evaluate the candidate locations using range information. In some embodiments, the indication of stage 714 may be a binary indicator indicating whether each respective candidate location is most likely to be the location of the base station. In some embodiments, the indication of stage 714 may be a likelihood that each respective candidate location is the location of the base station. In other embodiments, the indication of stage 714 may be a ranking of the candidate locations, indicating which candidate location is most likely and least likely to be the location of the base station.

At stage 716, the method 700 includes transmitting, to the location server, a request 650 to close a data connection with the location server. The mobile device 400 may not send the close connection request 650, e.g., if the mobile device 400 wants to keep the connection to the server 500 open. Also or alternatively, the server 500 may send a close connection request to the mobile device.

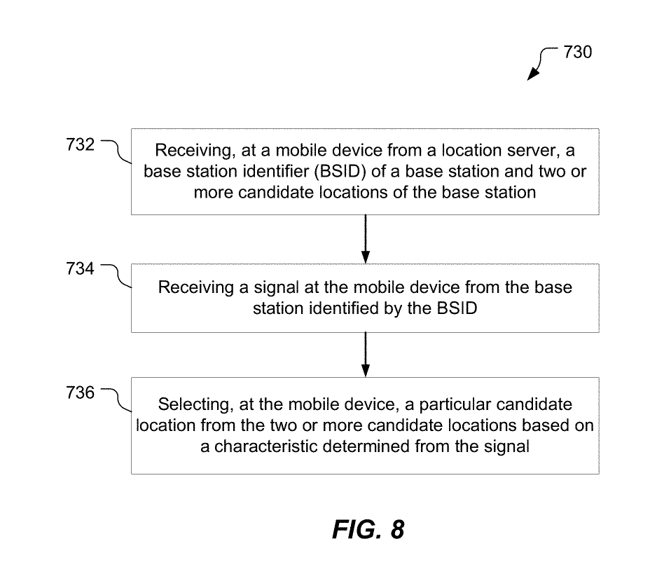

Referring to FIG. 8, with further reference to FIGS. 3-7, a method 730 of disambiguating between multiple candidate base station locations includes the stages shown. The method 730 is, however, an example only and not limiting. The method 730 can be altered, e.g., by having stages added, removed, rearranged, combined, performed concurrently, and/or having single stages split into multiple stages.

At stage 732, the method 730 includes receiving, from a location server, a base station identifier (BSID) of a base station and two or more candidate locations of the base station. As with stage 706 discussed above, the candidate locations may be sent from the location server in the form of a base station location information response. The BSID of the base station and the two or more candidate locations may be received as part of a base station almanac sent from the location server. The candidate locations may include global location information such as latitude, longitude and height information. Alternatively, the candidate locations may be indicated by non-global (local) information. For example, one or more of the candidate locations may be a location within a venue, such as a room within a building. The candidate location information may include estimates of the base station location calculated using range information previously sent by other mobile devices, and may include multiple candidate locations for each of one or more individual base stations.

At stage 734, the method 730 includes receiving a signal at the mobile device from the base station identified by the BSID. For example, the signal received may be the signal that includes the BSID and the two or more candidate locations, or another signal from the base station.

At stage 736, the method 730 includes selecting a particular candidate location from the two or more candidate locations based on a characteristic determined from the signal. For example, this may comprise determining which of the two or more candidate location is most likely the actual location of the base station based on the signal received in stage 734. The processor 410 may determine an expected range to each candidate location and the actual range to the base station 320, compare the actual range to the expected ranges, and determine that the actual base station location is the candidate location corresponding to the expected range that best matches the actual range. The mobile device 400 may use information from the signal and/or may measure information of the signal that allows the mobile device 400 to determine information such as the range from the mobile device 400 to the base station 320. For example, the signal may include a positioning reference signal (PRS) or other signal transmitted by the base station that the mobile device can use to determine a time delay between when the signal was sent from the base station 320 and when the signal was received by mobile device. The signal may be of a known or indicated energy and the mobile device 400 may measure a received signal strength of the signal and determine a range from the mobile device 400 to the base station 320 based on the energy difference from transmission by the base station 320 to receipt by the mobile device 400.

The selecting of the particular candidate location may be accomplished using one or more of several techniques. For example, selecting the particular candidate location from the two or more candidate locations may comprise selecting a candidate location of the two or more candidate locations that has a greatest correlation between the characteristic determined from the signal and a predicted signal characteristic associated with the particular candidate location. The method 730 may further include determining a location of the mobile device, the predicted signal characteristic may be a predicted distance between the mobile device and the particular candidate location based on the location of the mobile device and the particular candidate location, and the characteristic determined from the signal may be a distance based on a time difference of arrival between the signal and at least one other signal from at least one other base station.

Implementations of the method 730 may include one or more of the following features, and/or one or more other features. For example, the method 730 may include sending an indication of the particular candidate location to the location server. The method 730 may further include determining a location of the mobile device (e.g., the mobile device 400), and the indication of the particular candidate location sent to the location server e.g., the location server 500) may include an indication of the characteristic determined from the signal (e.g., distance from the mobile device 400 to the base station 320) and the location of the mobile device 400. Also or alternatively, the indication of the particular candidate location may comprise a likelihood value for each of the two or more candidate locations. Also or alternatively, the indication of the particular candidate location may comprise a ranking of the two or more candidate locations. The method 730 may include receiving, at the mobile device from the location server, a time bias associated with the BSID.

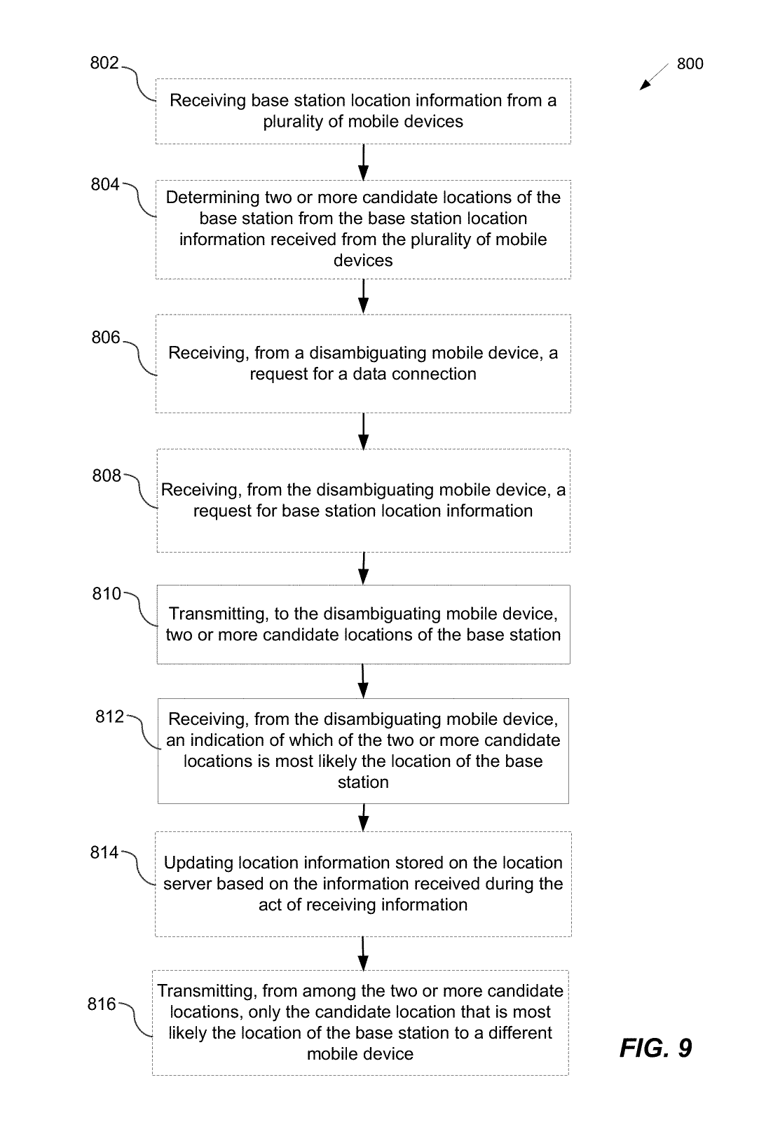

Referring to FIG. 9, with further reference to FIGS. 3-6, a method 800 of operating a location server includes the stages shown. The method 800 is, however, an example only and not limiting. The method 800 can be altered, e.g., by having stages added, removed, rearranged, combined, performed concurrently, and/or having single stages split into multiple stages. For example, the stages of method 800 illustrated with dashed lines may be omitted.

At stage 802, the method 800 includes receiving base station location information from multiple mobile devices. The mobile devices may include any of the mobile device that are within range of a particular base station and capable of communicating location information to the base station. The base station location information received from the mobile devices may include range information that indicates the distance between a respective mobile device and the base station. The base station location information received from the mobile devices may also include an indication of the location of the mobile device acquired from other sources, such as GNSS information.

At stage 804, the method 800 includes determining two or more candidate locations of the base station from the base station location information received from the mobile devices. As discussed above, multilateration techniques may be used to determine the two or more candidate locations. The candidate locations can be stored on the location server, or at a separate location, as part of a base station almanac (BSA).

At stage 806, the method 800 includes receiving, from a disambiguating mobile device, a request for a data connection. For example, the request may be the open connection request 610 described above. The disambiguating mobile device may be a mobile device that is not one of the mobile devices from stage 802. For example, referring to FIG. 1, the mobile devices of stage 802 that provide base station location information to the location server may be mobile devices 120 and the disambiguating mobile device may be mobile device 130, or any other mobile device (not shown) that is not in the straight line created by mobile devices 120. Referring to FIG. 2, the mobile devices of stage 802 that provide base station location information to the location server may be mobile devices 210 and the disambiguating mobile device may be mobile device 230, or any other mobile device (not shown) that is not substantially collinear with mobile devices 120.

At stage 808, the method 800 includes receiving, from the disambiguating mobile device, a request for base station information. For example, the base station location information request 620 may include information that identifies base stations near the disambiguating mobile device 400, information identifying the location of the disambiguating mobile device 400.

At stage 810, the method 800 includes transmitting, to the disambiguating mobile device, two or more candidate locations for one or more base station. The two or more candidate locations may be included in a base station location information response 630 sent in response to the received base station location information request 620. While method 800 only discusses sending candidate locations for one base station, candidate locations for multiple base stations may be sent to the disambiguating mobile device 400. For example, the location server may transmit candidate locations for base stations with which the disambiguating mobile device is presently in communication. Alternatively, the location server may transmit candidate locations for base stations that are within a certain region near the disambiguating mobile device. The location server may determine which base stations to send information about based on the information included in the base station location information request 620.

At stage 812, the method 800 includes receiving, from the disambiguating mobile device, an indication of which of the two or more candidate locations is most likely the location of the base station. As discussed above, the indication may be a binary indicator, a likelihood, a ranking of the candidate locations, or any other information indicating which candidate location is most likely the location of the base station. While method 800 only illustrates a single disambiguating mobile device 400 providing an indication to the location server 500, multiple disambiguating mobile devices may be in communication with the location server via the same base station and may provide indications of which of the two or more candidate locations is most likely the location of the base station.

At stage 814, the method 800 includes updating location information stored on the location server based on the information received during stage 812. The location information may be stored in a base station almanac on the location server or at some other storage location. The base station almanac may be a database, a table, or any other data structure that associates base stations with one or more locations. Updating the location information may include removing incorrect candidate locations from the data structure. Incorrect candidate locations may include any candidate location other than the candidate location that was determined to most likely be the location of the base station. Updating information stored on the location server may include waiting to update the information until a threshold number of disambiguating mobile devices have indicated (explicitly or implicitly, as discussed below) that a particular candidate location is most likely the actual location of the base station.

At stage 816, the method 800 includes transmitting, from among the two or more candidate locations, only the candidate location that is most likely the location of the base station to a different mobile device. In this way, once the two or more candidate locations have been disambiguated and one of the candidate locations has been determined to be the most likely to be the actual location of the base station, only that candidate location is transmitted to other mobile devices. For example, the two or more candidate locations may include a first candidate location that is most likely the location of the base station and a second candidate location that is not most likely the location of the base station. In response to receiving the indication from the disambiguating mobile device, the location server transmits, from among the first candidate location and the second candidate location, only the first candidate location to at least one different mobile device, other than the disambiguating mobile device.

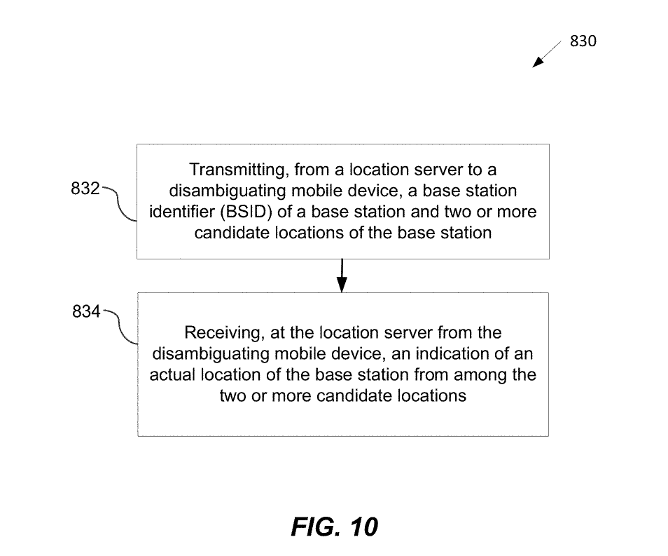

Referring to FIG. 10, with further reference to FIGS. 3-6, a method 830 of identifying an actual location of a base station includes the stages shown. The method 830 is, however, an example only and not limiting. The method 800 can be altered, e.g., by having stages added, removed, rearranged, combined, performed concurrently, and/or having single stages split into multiple stages. For example, the stages of method 800 illustrated with dashed lines may be omitted.

At stage 832, the method 830 includes transmitting, from a location server to a disambiguating mobile device, a base station identifier (BSID) of the base station and two or more candidate locations of the base station. For example, the location server 500 may send a BSID of the base station 320 to the mobile device 400 along with two or more possible locations of the base station 320. The BSID and the candidate locations may be sent as part of a base station almanac that may include further information about the base station 320. The mobile device 400 may be able to disambiguate which of the candidate locations is, or at least is likely to be, the actual location of the base station 320.

At stage 834, the method 830 includes receiving, at the location server from the disambiguating mobile device, an indication of the actual location of the base station from among the two or more candidate locations. The indication provided by the mobile device may explicitly indicate which of the candidate locations is, or at least is likely to be, the actual location of the base station 320. The indication provided by the mobile device may also, or instead, indicate which candidate location(s) is(are) not the actual location of the base station, thus implicitly indicating the candidate location that is the actual location of the base station.

Implementations of the method 830 may include one or more of the following features, and/or one or more other features. The method 830 may further include receiving, at the location server, base station location information from a plurality of mobile devices, and determining, at the location server, the two or more candidate locations of the base station from the base station location information received from the plurality of mobile devices. For example, the location server 500 may location information from multiple mobile devices, such as distance information to the base station (actual distance or information from which distance may be determined). The location server 500 may use the distance information to determine multiple possible locations for the base station, and send the possible locations to the mobile device 400. The distance information may be, for example, a distance from the respective mobile device to the base station, and a location of the respective mobile device. Also or alternatively, the method 830 may include updating location information stored on the location server based on the indication received from the mobile device of the actual location of the base station. The location server may update the location information in response to receiving the indication of the actual location of the base station from more than a threshold number of mobile devices. Also or alternatively, the method 830 may further include transmitting the actual location of the base station and the BSID to a different mobile device. For example, the location server 500 may send the BSID and the actual location of the base station 320 to a mobile device other than the mobile device 400 as part of a base station almanac for the base station 320. The other mobile device may use the actual location for determining a location of the other mobile device, and/or for another purpose. Also or alternatively, the method 830 may include transmitting a time bias of the base station to the disambiguating mobile device.

Other Considerations

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Additionally, an indication that a “location” or a “position” is transmitted or received is not an indication that the abstract concept of a location or position is sent, but rather that some information or an indication of the location or position is being transmitted or received.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “processor-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

What is claimed is:

1. A method of determining a location of a base station, the method comprising:
receiving, at a mobile device from a location server, a base station identifier (BSID) of the base station and two or more candidate locations of the base station;
receiving a signal at the mobile device from the base station identified by the BSID; and
selecting, at the mobile device, a particular candidate location from the two or more candidate locations based on a characteristic determined from the signal.

2. The method of claim 1, wherein selecting the particular candidate location from the two or more candidate locations comprises selecting a candidate location of the two or more candidate locations that has a greatest correlation between the characteristic determined from the signal and a predicted signal characteristic associated with the particular candidate location.

3. The method of claim 2, wherein the method further comprises determining a location of the mobile device, and wherein:
the predicted signal characteristic is a predicted distance between the mobile device and the particular candidate location based on the location of the mobile device and the particular candidate location; and
the characteristic determined from the signal is a distance based on a time difference of arrival between the signal and at least one other signal from at least one other base station.

4. The method of claim 1, further comprising sending an indication of the particular candidate location to the location server.

5. The method of claim 4, further comprising determining a location of the mobile device, and wherein the indication of the particular candidate location includes an indication of the characteristic determined from the signal and the location of the mobile device.

6. The method of claim 4, wherein the indication of the particular candidate location comprises a likelihood value for each of the two or more candidate locations.

7. The method of claim 4, wherein the indication of the particular candidate location comprises a ranking of the two or more candidate locations.

8. The method of claim 1, further comprising receiving, at the mobile device from the location server, a time bias associated with the BSID.

9. The method of claim 1, wherein receiving the BSID of the base station and the two or more candidate locations of the base station comprises receiving a base station almanac.

10. A mobile device comprising:
a memory;
a transceiver configured to receive signals from a base station and to send signals to the base station; and
a processor operably coupled to the memory and the transceiver, wherein the processor is configured to:
receive, from a location server, a base station identifier (BSID) of the base station and two or more candidate locations of the base station;
receive a signal from the base station identified by the BSID;
determine a characteristic from the signal; and
select a particular candidate location from the two or more candidate locations based on the characteristic determined from the signal.

11. The mobile device of claim 10, wherein the processor is configured to select, as the particular candidate location, a candidate location from the two or more candidate locations with that has a greatest correlation between the characteristic determined from the signal and a predicted signal characteristic associated with the particular candidate location.

12. The mobile device of claim 11, wherein the processor is further configured to:
determine a location of the mobile device; and
determine the predicted signal characteristic;
wherein the predicted signal characteristic is a predicted distance between the mobile device and the particular candidate location based on the location of the mobile device and the particular candidate location; and
wherein the characteristic determined from the signal is a distance based on a time difference of arrival between the signal and at least one other signal from at least one other base station.

13. The mobile device of claim 10, wherein the processor is further configured to send, via the transceiver, an indication of the particular candidate location to the location server.

14. The mobile device of claim 13, wherein the processor is further configured to determine a location of the mobile device, and wherein the indication of the particular candidate location includes an indication of the characteristic determined from the signal and the location of the mobile device.

15. The mobile device of claim 13, wherein the indication of the particular candidate location comprises a likelihood value for each of the two or more candidate locations.

16. The mobile device of claim 13, wherein the indication of the particular candidate location comprises a ranking of the two or more candidate locations.

17. The mobile device of claim 10, wherein the processor is configured to receive the BSID of the base station and the two or more candidate locations of the base station as part of a base station almanac.

18. A method of identifying an actual location of a base station, the method comprising:
transmitting, from a location server to a disambiguating mobile device, a base station identifier (BSID) of the base station and two or more candidate locations of the base station; and
receiving, at the location server from the disambiguating mobile device, an indication of the actual location of the base station from among the two or more candidate locations.

19. The method of claim 18, wherein the method further comprises:
receiving, at the location server, base station location information from a plurality of mobile devices; and
determining, at the location server, the two or more candidate locations of the base station from the base station location information received from the plurality of mobile devices.

20. The method of claim 19, wherein the base station location information received from a respective mobile device of the plurality of mobile devices includes a distance from the respective mobile device to the base station, and a location of the respective mobile device.

21. The method of claim 18, wherein the method further comprises updating location information stored on the location server based on the indication.

22. The method of claim 21, wherein updating the location information is performed in response to receiving the indication of the actual location of the base station from more than a threshold number of mobile devices.

23. The method of claim 18, further comprising transmitting the actual location of the base station and the BSID to a different mobile device.

24. The method of claim 18, further comprising transmitting a time bias of the base station to the disambiguating mobile device.

25. A location server comprising:
a memory;
a communications subsystem configured to receive signals from a base station and to send signals to the base station for communication with a mobile device; and
a processor operably coupled to the memory and to the communications subsystem, wherein the processor is configured to:
transmit, to a disambiguating mobile device via the communications subsystem, a base station identifier (BSID) of the base station and two or more candidate locations of the base station;
receive, from the disambiguating mobile device via the communications subsystem, an indication of an actual location of the base station from among the two or more candidate locations; and
update, based on the indication of the actual location of the base station, location information stored in the memory.

26. The location server of claim 25, wherein the processor is configured to update the location information in response to receiving the indication of the actual location of the base station from more than a threshold number of mobile devices.

27. The location server of claim 25, wherein the processor is further configured to transmit the actual location of the base station and the BSID to a different mobile device.

28. The location server of claim 25, wherein the processor is further configured to:
receive, via the communications subsystem, base station location information from a plurality of mobile devices; and
determine the two or more candidate locations of the base station from the base station location information received from the plurality of mobile devices.

29. The location server of claim 25, wherein the processor is further configured to transmit a time bias of the base station to the disambiguating mobile device.
